(19) United States
(12) Patent Application Publication
(10) Pub. No.: US 2020/0198256 A1
(43) Pub. Date: Jun. 25, 2020

(54) Intermediary Protective Bonding Layer Onto Which an Additional Part(s) is to be Adhered for Both Cosmetic Appeal and Ease of Undamaged Removal

(71) Applicant: Chet Baigh, Chicago, IL (US)

(72) Inventor: Chet Baigh, Chicago, IL (US)

(21) Appl. No.: 16/718,185

(22) Filed: Dec. 18, 2019

Related U.S. Application Data
(60) Provisional application No. 62/780,935, filed on Dec. 18, 2018.

(51) Int. Cl. B29C 65/48; B60R 13/04

(52) U.S. Cl. CPC B29C 65/48; B29L 2031/30; B60R 13/04

(57) ABSTRACT

This embodiment of the present invention provides for a method of protecting substrate surfaces. The method of this invention includes the steps of adhering to the Paint surface a plurality of removable impermeable protective layers onto the top of which a plurality of glue types may be used to adhere a plurality of additional parts. An embodiment of the present inventive method will be hereinafter referred to as a “Intermediary Protective Bonding Layer” (“IPBL”).

### CROSS REFERENCE TO RELATED APPLICATIONS

This application claims the benefit of U.S. Provisional Application No. 62/780,935, filed Dec. 18, 2018.

### STATEMENT REGARDING FEDERALLY SPONSORED RESEARCH OR DEVELOPMENT.

Not Applicable

### THE NAMES OF THE PARTIES TO A JOINT RESEARCH AGREEMENT.

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB).

Not Applicable

### STATEMENT REGARDING PRIOR DISCLOSURES BY THE INVENTOR OR A JOINT INVENTOR.

Not Applicable

### BACKGROUND OF THE INVENTION

Often, automotive parts will be desired to be adhered to the exterior of an automobile without drilling or otherwise making holes for screws, bolts and/or rivets. Drilling causes damage to the Paint, clear coat and the underlying structural body. Without an embodiment of the present invention, one might adhere the part directly to the Paint and/or clear coat surface using only glue or tape, however when attempting to remove the part, considerable difficulty and damage to the Paint is likely to occur. Thus, a protective intermediary layer which bonds to the Painted surface and to the top of which a part is glued will be desirable.

### FIELD OF THE INVENTION

The present invention method relates to an initial automotive paint and/or clear coat protection intermediary layer onto which an additional auto part is to be adhered and be easily removable without major damage to the clear coat or paint substrate.

### BACKGROUND ART

### Information Disclosure Statement Initials

Patent No.: U.S. Pat. No. 9,028,629 B2

Title: Methods of refurbishing an adhered component and composites comprising adhered components

Date of Patent: May 12, 2015

Inventors: Carlos A. Fracchia, Ballwin, Mo. (US);

Terry A. Sewell, Ballwin, Mo. (US);

Charles A. Rhodes, Saint Louis, Mo. (US)

The invention relating to Methods of refurbishing an adhered component and composites comprising adhered components pertains to some aspects to the present invention. Like the present invention titled, “Intermediary Protective Bonding Layer Onto Which an Additional Part(s) is to be Adhered for both Cosmetic Appeal and Ease of Undamaged Removal” the patent cited does use layers of adhesives and a permeable woven scrim to adhere a consumable second component for replacement. The differences at the core of the cited patent and the present invention are as follows. The adhesive woven fabric of the cited patent is permeable and allows only for the two components to be cleaved apart, thereby leaving a residue and a permanently damaged original surface. The permeable nature of the scrim allows permanent adhesive to permeate. The consumable nature of the second component demands that that the method of the cited component does not have the utility of leaving an undamaged original surface (the non-consumable component), but merely a means to remove and refurbish or replace an exterior consumable component. The cited patent uses an adhesive stack wherein the adhesives comingle and impregnate. The adhesives and/or scrim used are not ocularly transparent or otherwise cosmetically desirable such as paint protective film so as to preserve the cosmetic nature of the underlying original surface during the time the present invention is assembled.

### SUMMARY OF THE INVENTION

This embodiment of the present invention provides for a method of protecting substrate surfaces. The method of this invention includes the steps of adhering to the Paint surface a plurality of removable impermeable protective layers onto the top of which a plurality of glue types may be used to adhere a plurality of additional parts. An embodiment of the present inventive method will be hereinafter referred to as a “Intermediary Protective Bonding Layer” (“IPBL”). An automotive (among others) industry exists wherein numerous products are designed to protect the valuable paint, clear coat, wax coat, synthetic wax coating, ceramic, glass and/or other coat, and/or substrate beneath against scratches, chips, vandalism among other unpredictable aversive occurrences, and be removable (such an embodiment of the substrate shall together be referred to as the “Paint” with regard to the further and prior use herein, whereby the automotive industry is primarily exemplified for illustrative and practical purposes, whereas a plurality of applicable industries exist). Such protective products may have a plurality of forms, compositions, adhesives and/or other properties. However, with regard to protecting the Paint in the automotive industry, this form is most often a flexible ocularly transparent sheath, sheet, covering, wrap, bra, clear bra, coating, film, extrusion or other embodiment, which is often incorporates an adhesive backing layer (or plurality of adhesive layers and/or sheathes) and may be clear, colored or patterned. This material (which shall for the sake of this embodiment of the present inventive method constitute the IPBL) in combination with a topical adhesive/glue which is planned to mate the additional part to the automobile constitutes the improved inventive method. The area which the IPBL may cover is an area at least as large as the contacting surface area of the added part(s), which may include any extra surface area which the topical glue may require, or additional layers of topical glue which may be used to reinforce the part(s) bonding to the top surface of the IPBL, or for cosmetic reasons. Further, the surface area covered by the IPBL may be larger than the minimum described. The surface area may be extended to provide additional strength of adherence and/or fail-proof extension areas along the surface of the Paint. The covered surface area(s) may constitute a plurality of segments. The surface area(s) may also constitute a plurality of segments should the additional part(s) have a plurality of contact areas. Further, the surface area(s) may constitute a plurality of segments or large single segment which covers the entire Painted surface; whether or not that entire Painted surface constitutes the Painted areas of a whole structural body panel or the whole painted surface(s) of the entire automobile. In addition to the Paint, the covered surface area(s) may constitute glass, metal, plastic, composite, epoxy, resin, laminate and/or other part(s) which may exist on the automobile, or be added by any means.

### BRIEF DESCRIPTION OF THE DRAWINGS

FIG. 1 is a front perspective view of view of an automobile onto which the IPBL film sheet(s) are being adhered to the Paint;

FIG. 2 is a front perspective view of an automobile which has the IPBL sheet(s) adhered onto the Paint, onto which added part(s) are being bonded with the topical;

FIG. 3 is a front perspective view of an automobile which has the IPBL sheet(s) adhered onto the Paint and the part(s) adhered to the top of the IPBL, but also depicting an optional additional bead or layer of glue for further strength;

FIG. 4 illustrates a front perspective view of an automobile which has the IPBL sheet(s) and part(s) bonded to form an assembly which is depicted as being removed without difficulty and/or harming the Paint.

### DETAILED DESCRIPTION OF THE INVENTION

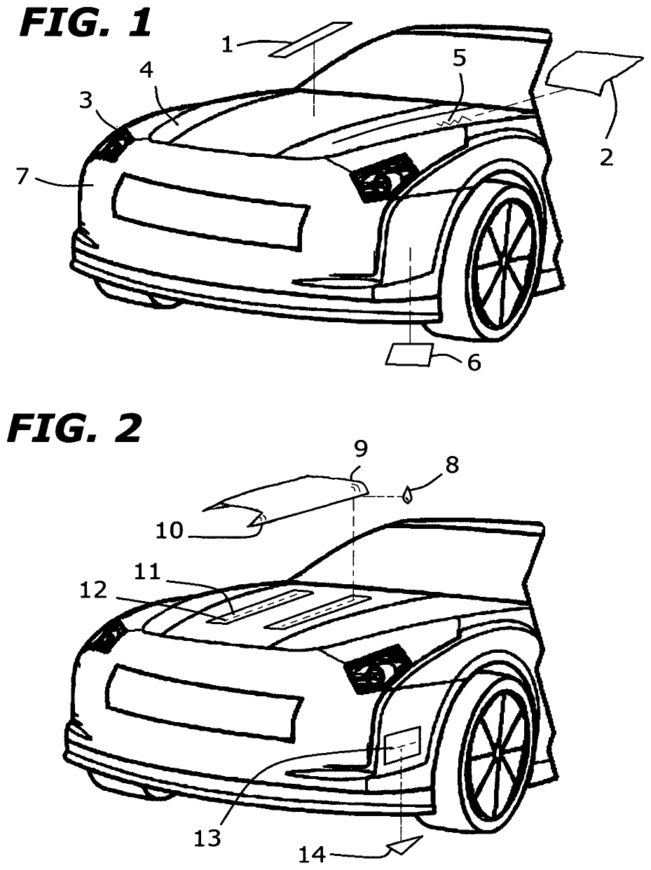

With reference to the drawings shown in FIGS. 1 to 4, the following description regards various example structures, systems, and methods. The systems, structures and methods illustrated compose aspects of the invention which may be practiced. It is to be understood that other specific arrangements of parts, structures, examples, systems, and the like, may be utilized and structural and functional modifications may be made without departing from the scope of embodiments of the present invention. With reference to the drawings, and wherein the improvement comprises the methodical steps combining generally: a Painted surface 7, a plurality of IPBL self-adhering film segments 1, 6, and/or a large sheet of IPBL 2 which is large enough to cover an entire structural body panel (a hood 4 in this case), an additional part(s) 9, and 14, and a topical adhesive 8, to bond the surface-contacting areas 10 of the parts(s) 9, and 14, to the IPBL 1, 2 and/or 6.

The embodiment of the present invention as illustrated in FIG. 1 generally illustrates an automobile 3, which has standard areas covered with Paint 7. Often, an IPBL 1, 2, and/or 6 will have self-adhering layers which bonds the IPBL 1,2 and/or 6 to the Paint 7. That step is illustrated with directional arrows in FIG. 1. Often, as illustrated in the case of IPBL 1, a plurality of separate IPBL sheets may be used to adhere a single part which may have a plurality of surface-contacting areas 10 which may adhere to desired areas of the IPBL 12. In all cases with the IPBL, a plurality of layers of IPBL 1, 2 and/or 6 may be stacked on top of each other. In other cases, it may be desirable to cover a plurality of whole structural body part(s) with IPBL (as illustrated with the example hood 4 being totally covered 5, depicted partially with dashed and zigzag crop lines) using a large sheet of IPBL 2. Other embodiments include single IPBL sheets such as 6 onto which a singular body part along a desired position.

FIG. 2 illustrates a narrower scope of embodiments by depicting only the IPBL arrangements 1, and 6 and not the fully covered IPBL 2. It should also be noted that a plurality of IPBL sheets may be used to cover the entire Paint surface of the whole car- including areas which may be glass plastic and/or other surface types. FIG. 2 generally illustrates the step of adhering the part(s) 9 and 14 to the top of the previously adhered IPBL areas 11 and 13 along the envisioned intended positions 12. A coating of glue/adhesive 8 is to be spread along a plurality of areas of the surface-contacting faces 10 of the parts 9 and 14 and/or along the intended positions, 12. The parts 9 and 14 are to be placed or pressed against the top(s) of the IPBL surface(s) 11, 13 and/or 5 (5, as depicted in FIG. 1). Whether or not the IPBL is as strong as the topical glue/adhesive, it may have a greater surface are on which to bond, and thus maintain substantially similar integrity.

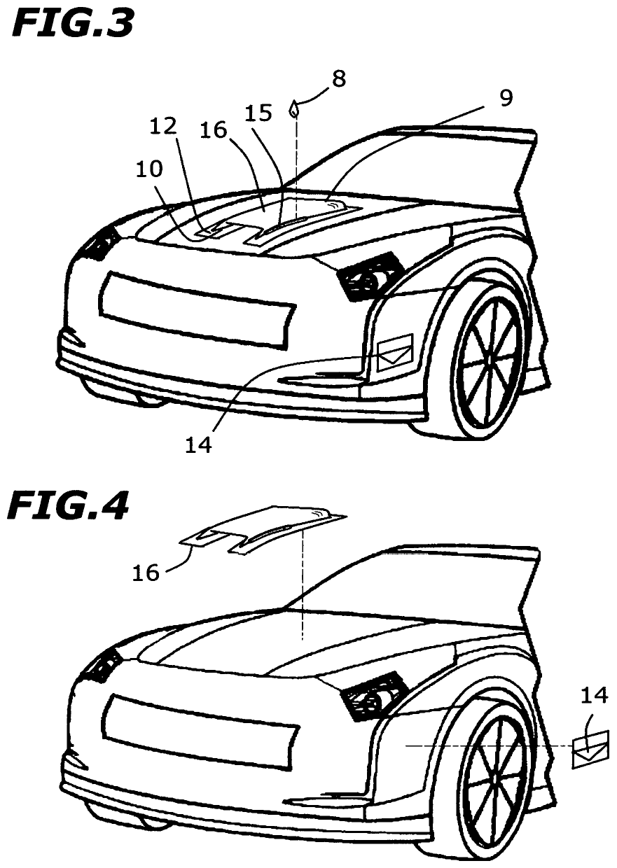

FIG. 3 illustrates an embodiment of the present invention with the assembled part(s) having been bonded to the IPBL which was itself bonded to the Paint. Together, they (12, 9, 8, and 15) comprise the assembly 16. A further embodiment of the present invention depicts an outer layer of topical glue/adhesive 15 beaded and/or shaped along a plurality of outer lengths and faces along the surface-contacting areas, 10. This outer layer adhesive (“OLGA”) may be used in tandem with and/or in place of, the topical glue/adhesive from the prior topical bonding step. The OLGA strips are thick enough to span and bond both the IPBL to the part's(s') outer surface adjacent to the surface-to-surface contact area(s). This OLGA may aid in adding strength, fill any gaps present between the part(s) surface-contacting area(s) 10, and/or making removal easier. The OLGA may constitute the entire bond used between the IPBL and part(s).

FIG. 4 illustrates the removal of the assemblies 16. When removing the assemblies, the IPBL will come off the Paint easily. When taken off, the part(s) which were bonded to the top of the IPBL will come off as well. This leaves the Paint unharmed and removal of the part(s) are achieved easily.

1. A method of protecting a plurality of original automotive surfaces when installing a plurality of additional parts, comprising:
adhering to said automobile's external surface a plurality of fully impermeable removable protective sheaths which are cosmetically desirable;
applying a permanent adhesive to the external surface of the said plurality of removable protective sheaths and/or to the plurality of said additional parts onto the areas where the objects will bond; and
allowing a sufficient amount of time for the adhesives to bond, thereby joining the assembly which may easily be removed without damage to said original automotive surfaces.
